(19) United States
(12) Patent Application Publication
(10) Pub. No.: US 2023/0202171 A1
(43) Pub. Date: Jun. 29, 2023

(54) IMAGE RECORDING APPARATUS

(71) Applicant: BROTHER KOGYO KABUSHIKI KAISHA, Nagoya (JP)

(72) Inventors: Mitsugi TANAKA, Nagoya (JP); Yoshikazu SHIMIZU, Kasugai (JP); Takahiro NISHIMOTO, Ogaki (JP)

(21) Appl. No.: 18/069,341

(22) Filed: Dec. 21, 2022

(30) Foreign Application Priority Data
Dec. 24, 2021 (JP) 2021-210390

(51) Int. Cl. B41J 2/14; B41J 11/00; B41J 13/02; B41J 29/377

(52) U.S. Cl. CPC B41J 2/14; B41J 11/007; B41J 11/0015; B41J 13/02; B41J 29/377; B41J 29/13

(57) ABSTRACT

There is provided an image recording apparatus including: a casing; a conveyor positioned inside the casing and configured to convey a sheet in a conveying direction; a recording part positioned inside the casing and configured to record an image, with an ink, on the sheet conveyed by the conveyor; a heater positioned inside the casing, on a downstream side in the conveying direction of the recording part, and configured to heat at least one of the sheet and the ink; a reading part positioned inside the casing, on the downstream side in the conveying direction of the heater, and configured to optically read the image recorded on the sheet; and a blower positioned inside the casing and configured to generate an air current toward the reading part and toward the sheet located at a position on the downstream side in the conveying direction of the heater.

### REFERENCE TO RELATED APPLICATIONS

This application claims priority from Japanese Patent Application No. 2021-210390 filed on Dec. 24, 2021. The entire content of the priority application is incorporated herein by reference.

### BACKGROUND ART

In a certain publicly known printer, a recording head, a drying-fixing part, a cockling state detecting part, and a winding part (take-up part) are arranged in this order from the upstream toward the downstream of a conveying path. The recording head discharges or ejects an ink containing conductive particles from a plurality of nozzles onto a paper medium. The drying-fixing part includes an inducting heating part, etc., and heats the paper medium and/or the conductive particles to thereby fix an ink image to the paper medium. The paper medium which has passed the fixing-drying part is wound, as a printed item, by the winding part.

The cockling state detecting part includes a non-contact displacement sensor of a line laser type, and detects a cockling amount in the paper medium. In the above-described printer, a controller adjusts an output condition of the induction heating part so that the cockling amount detected in the cockling state detecting part becomes to be not more than a threshold value.

### DESCRIPTION

A printer of the ink-jet system is required to output a large number of a high quality printed item per unit time and/or to have a small size. For this purpose, it is desired that the drying-fixing part and the cockling state detecting part are arranged adjacent or close to each other in the conveying path. In a case, however, that water content keeps to be evaporated even after the printed item has passed the drying-fixing part, a water droplet due to dew condensation adheres to the cockling state detecting part which is positioned on the downstream side with respect to the drying-fixing part. In a case that the water droplet falls onto the paper medium, the ink image is blurred in some cases.

An object of the present disclosure is to provide a technique which is contributable to the suppression of the generation of dew condensation in the reading part and the technique which is also contributable to the fixing an image to the recording medium more quickly.

According to an aspect of the present disclosure, there is provided an image recording apparatus including: a casing; a conveyor; a recording part; a heater; a reading part; and a blower. The conveyor is positioned inside the casing and is configured to convey a sheet in a conveying direction. The recording part is positioned inside the casing and is configured to record an image, with an ink, on the sheet conveyed by the conveyor. The heater is positioned inside the casing, on a downstream of the recording part in the conveying direction, and is configured to heat the sheet and/or the ink. The reading part is positioned inside the casing, on the downstream of the heater in the conveying direction, and is configured to optically read the image recorded on the sheet. The blower is positioned inside the casing and is configured to generate an air current toward the reading part and toward the sheet located at a position on the downstream of the heater in the conveying direction.

The reading part is cooled by the air current generated by the blower. However, vapor generated from the sheet which passed the heater is blown by the air current of the blower. Accordingly, any adhesion of the water droplet, due to the dew condensation, to the reading part is suppressed, and the ink is dried quickly.

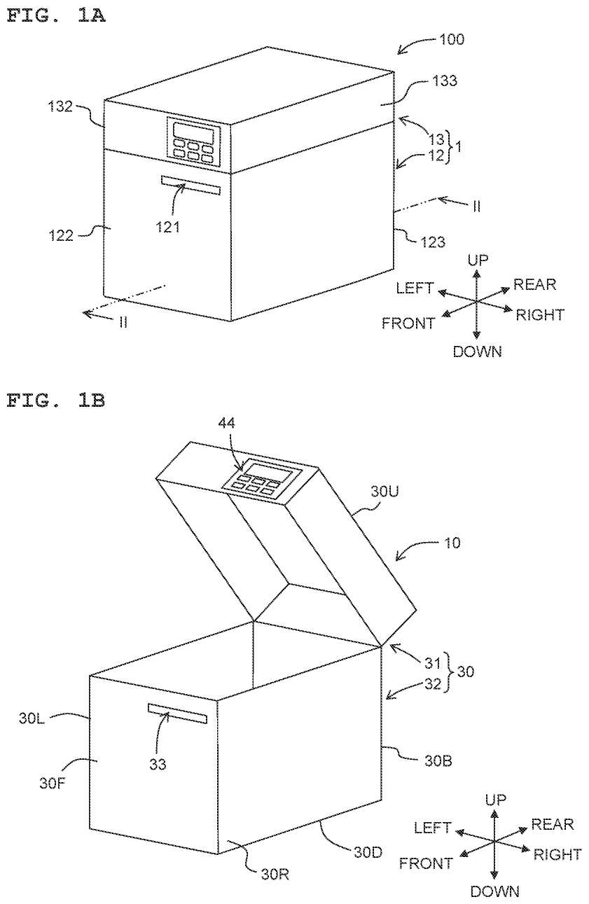

FIG. 1A is a perspective view schematically depicting the outer appearance of a printer 10, and FIG. 1B is a perspective view schematically depicting the printer 10 in which a casing cover 31 is at an open position.

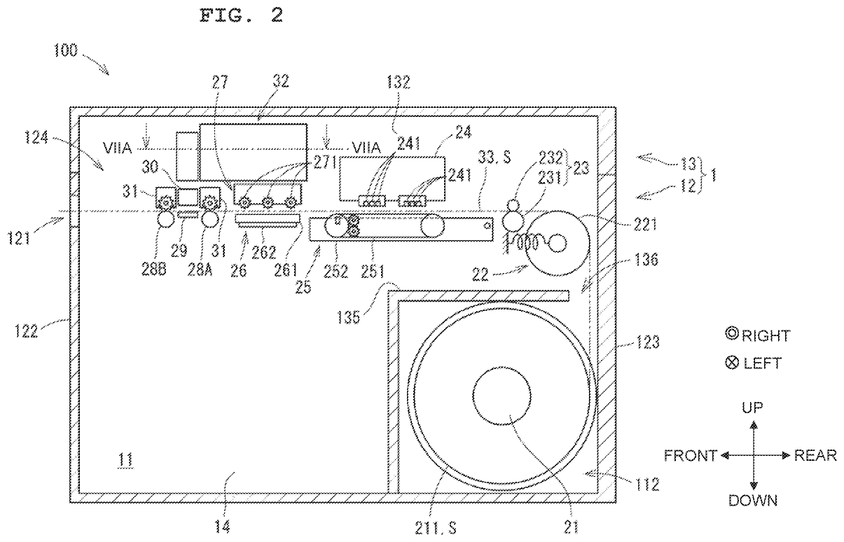

FIG. 2 is a schematic view depicting a vertical cross section of the printer 10 along a II-II line in FIG. 1A.

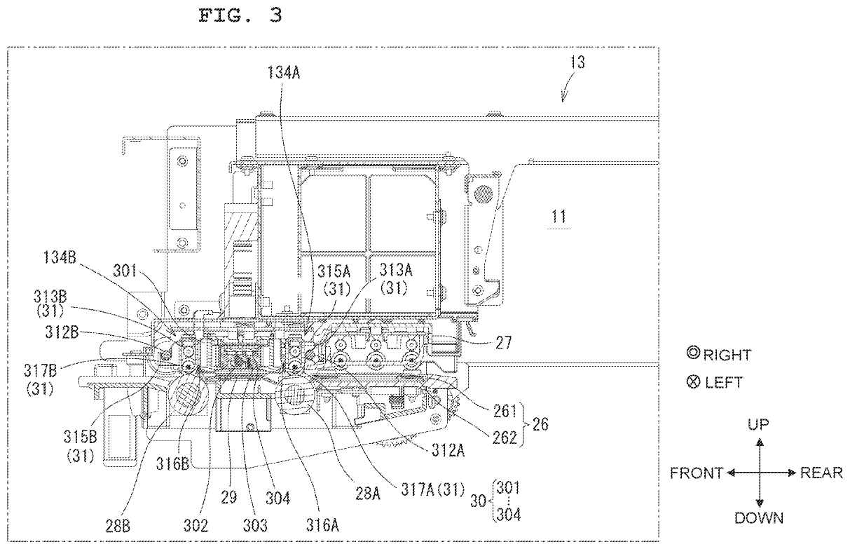

FIG. 3 is an enlarged view of a CIS unit 30 and the peripheral thereof in a vertical cross section of the casing cover 13 along a II-II line in FIG. 1A.

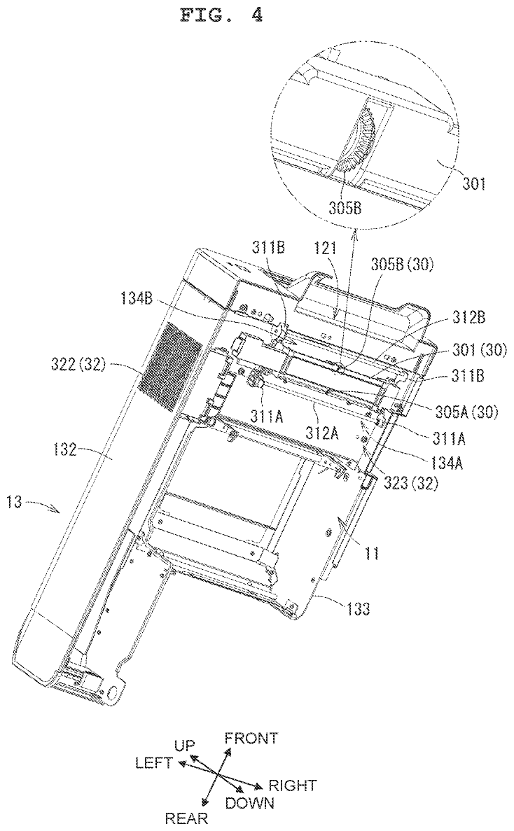

FIG. 4 is a perspective view of a bottom surface of the CIS unit 30 of FIG. 2, depicting a state that a spur holder unit 31 is detached.

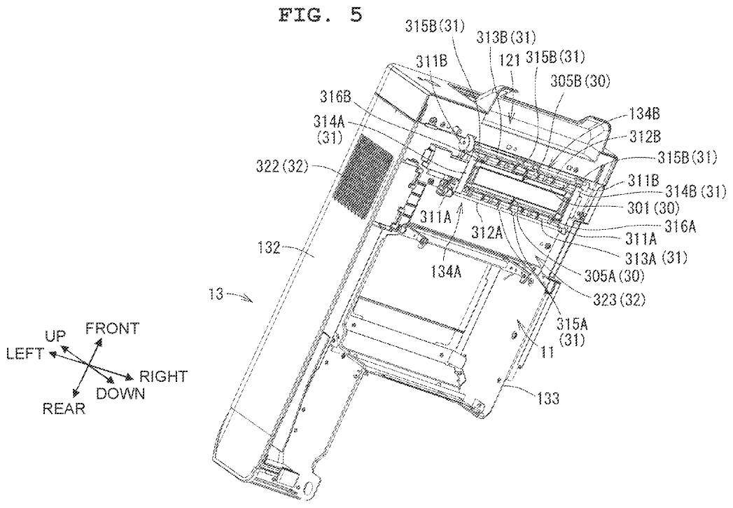

FIG. 5 is a perspective view of the bottom surface of the CIS unit 30 of FIG. 2, depicting a state that the spur holder unit 31 is installed.

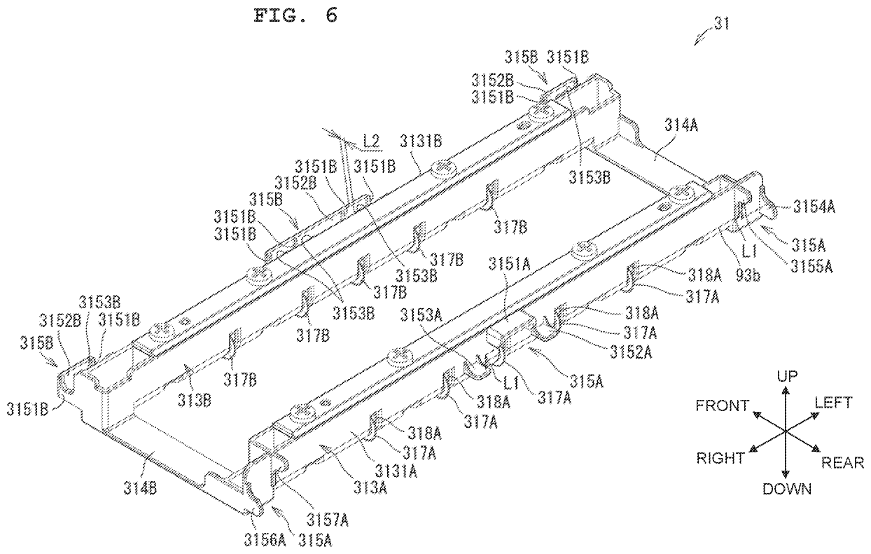

FIG. 6 is a perspective view of the spur holder unit 31.

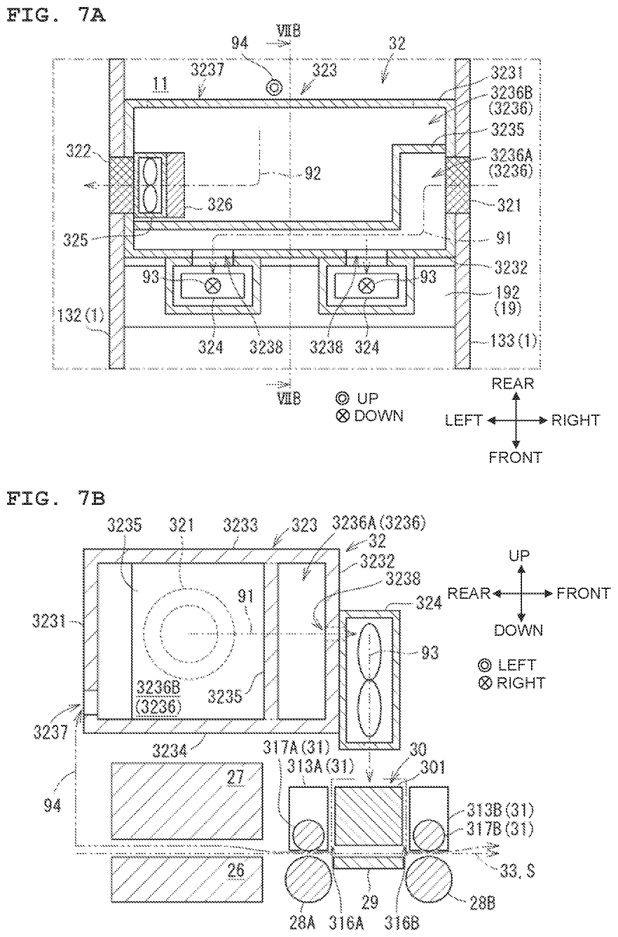

FIG. 7A is a schematic view depicting a cross section of a cooling unit 32 and the peripheral configuration thereof along a VIIA-VIIA line of FIG. 2, and FIG. 7B is a schematic view depicting a vertical cross section of the cooling unit 32 and the peripheral configuration thereof along a VIIB-VIIB line of FIG. 7A

In the following, a printer 100 according to an embodiment of the present disclosure will be explained. Note that the embodiment which is to be explained below is merely an example of the present disclosure; it is needless to say that the embodiment can be appropriately changed without changing the gist of the present disclosure.

An up-down direction is defined, with a state in which the printer 100 is installed usably (a state of FIG. 1A), as the reference. A front-rear direction is defined, with a side on which a discharge port 121 is provided on the printer 100 is defined as a front side (front surface); and a left-right direction is defined, with the printer 100 as seen from the front side (front surface).

<Casing 1 of Printer 100>

As depicted in FIGS. 1A, 1B and FIG. 2, the printer 100 (an example of an “image recording apparatus”) records an image on a sheet S in the ink-jet recording system.

In the printer 100, the casing 1 has a substantially parallelepiped shape and demarcates, from the outside, an internal space 11 of the printer 100. The casing 1 is constructed of a casing case 12 and a casing cover 13. The discharge port 121 is formed in a front wall 122 of the casing case 12. The discharge port 121 is a through hole having a rectangular shape which is long in the left-right direction. The casing cover 13 is attached to a rear wall 123 by a bearing and a shaft (which are omitted in the drawings). The casing cover 13 pivots or rotates between a close position (the position depicted in FIG. 1A) and an open position (the position depicted in FIG. 1B) in a circumferential direction of a rotation axis 131 (see FIG. 1B) of the shaft. The rotation axis 131 is parallel to the left-right direction. The casing cover 13 at the close position closes an opening 124 which is at an upper end in the casing case 12; the casing cover 13 at the open position opens or releases the opening 124. Note that the configuration inside the casing 1 is not depicted in FIG. 1B. Further note that in the following description, unless particularly noted, the term “casing cover 13” means the “casing cover 13 which is at the close position”.

<Internal Configuration of Printer 100>

As depicted in FIG. 2, the printer 100 is provided with, in the internal space 11, a roll holder 21, a tensioner 22, a conveyor 23, a recording head 24, a supporting mechanism 25, a heater 26, a heater cover 27, discharging rollers 28A, 28B, a reference plate 29, a CIS unit 30, a spur holder unit 31 and a cooling unit 32.

<Roll Holder 21>

In the internal space 11, a partition wall 135 defines a sheet accommodating space 112 at a location closer to a rear part and closer to a lower part of the internal space 11. The roll holder 21 has a spindle, flange, etc., and is supported by a non-illustrated frame in the inside of the sheet accommodating space 112. A roll body 211 is installed in the roll holder 21. In the roll body 211, the sheet S is wound around a core tube of the roll body 211. Note that it is allowable that the roll body 211 does not have the core tube, and may be the sheet S which is wound in a roll shape. Further note that a long fan folded paper sheet or a cut paper sheet may be accommodatable in the sheet accommodating space 112. The roll body 211 is installed in the spindle of the roll holder 21 so that the axial core of the roll body 211 is parallel to the left-right direction. Further, the left end and the center in the left-right direction of the roll body 211 are positioned, respectively, to reference positions in the inside of the internal space 11 in a case that the roll body 211 is installed in the roll holder 21. The roll holder 21 supports the roll body 211 to be rotatable about the axial core of the spindle. A gap 136 via which the sheet S passes is defined between a rear end of the partition wall 135 and the rear wall 123. The sheet S is pulled or drawn from the roll body 211, passes the gap 136 and extends toward the tensioner 22.

<Tensioner 22>

The tension 22 is positioned above the partition wall 135 and in the vicinity of the rear wall 123. The tensioner 22 is supported by non-illustrated frames which are positioned in the vicinity of the both ends in the left-right direction in the internal space 11, and the tensioner 22 extends, at a location between the frames, in the left-right direction. The tensioner 22 is movable in the front-rear direction, and is urged rearward by a spring. The tensioner 22 has a curved surface 221 which is oriented to the outside of the casing 1. The sheet S is wound by the curved surface 221 from therebelow, passes an upper end of the curved surface 221, and extends toward the conveyor 23 which is positioned in front of the tensioner 22. Tension is applied to the sheet S wound by the tensioner 22.

<Conveyor 23>

In the conveyor 23, a drying roller 231 and a pinch roller 232 are supported by the frames at a location in front of the tensioner 22, and extend in the left-right direction. The pinch roller 232 makes contact with an upper end of the driving roller 231 from thereabove. The driving roller 231 rotates about an axial core which is parallel to the left-right direction, by a driving force generated in a non-illustrated motor. The driving roller 231 nips the sheet S from the tensioner 22 with the pinch roller 232, and feeds the sheet S to a conveying path 33 starting from the nip and reaching up to the discharge port 121. The sheet S is conveyed frontward (an example of a “conveying direction”) in the conveying path 33.

<Recording Head 24>

The recording head 24 (an example of a “recording part”) is supported by the frames at a position which is in front of the pinch roller 232 and above the supporting mechanism 25. The recording head 24 discharges or ejects an ink (an example of a “liquid”) from a plurality of nozzles 241, which is formed in a lower surface of the recording head 24, toward the sheet S supported by the supporting mechanism 25. With this, an image by the ink is recorded on a recording surface (an example of a “first surface”) of the sheet S. The ink is supplied to the recording head 24 from a non-illustrated ink tank via a non-illustrated tube. The ink is a PP ink containing water, a pigment and thermoplastic resin fine particles.

<Supporting Mechanism 25>

The supporting mechanism 25 is positioned at a location in front of the pinch roller 232 and immediately below the recording head 24, and is supported by the frames. The supporting mechanism 25 has a conveying belt 251, and a supporting part 252 which supports the sheet S at the both sides in the left-right direction of the conveying belt 251. The conveying belt 251 rotates by a driving force generated by a non-illustrated motor. Specifically, a conveying surface, in the conveying belt 251, which faces the recording head 24 at a location immediately below the recording head 24 runs frontward. With this, the sheet S fed from the conveyor 23 is frictionally conveyed frontward and fed to the heater 26 positioned in front of the supporting mechanism 25. The supporting part 252 has a supporting surface which spreads in the front-rear direction and the left-right direction at a position in the up-down direction which is substantially same as that of the conveying surface of the conveying belt 251. The supporting surface supports the sheet S which is (being) conveyed at a location immediately below the recording head 24 and maintains the distance in the up-down direction between the nozzles 241 and the sheet S. Note that the printer 100 may attract the sheet S by suction to the supporting surface by a non-illustrated sucking mechanism.

<Heater 26>

The heater 26 (an example of a “heater”) is supported by the frames at a location in front of the supporting mechanism 25 and extends in the left-right direction. The heater 26 has a heat transfer plate 261 and a film heater 262. The heat transfer plate 261 is formed of metal, and has a supporting surface which spreads in the front-rear direction and the left-right direction at a position in the up-down direction which is substantially same as that of the conveying surface of the conveying belt 251. The sheet S fed from the supporting mechanism 25 is conveyed frontward on the supporting surface of the heat transfer plate 261. The film heater 262 is fixed to a lower surface of the heat transfer plate 261, and generates heat under a control of a non-illustrated controller. This heat is transmitted, via the heat transfer plate 261, to the sheet S on the heat transfer plate 261.

<Heater Cover 27>

The heater cover 27 is located at a position above and apart from the heater 26 to some extent, and spreads in the front-rear direction and the left-right direction between a left wall 132 and a right wall 133 (see FIG. 1B) of the casing cover 13. The heater cover 27 covers the entirety of the supporting surface of the heat transfer plate 261. Three spur rollers 271 are arranged side by side in the front-rear direction, at a location closer to the left inside the heater cover 27. Similarly, three spur rollers 271 are also arranged side by side in the front-rear direction, at a location closer to the right inside the heater cover 27. Each of the spur rollers 271 is supported by the heater cover 27 to be rotatable about the rotation axis parallel to the left-right direction. A lower end of each of the spur rollers 271 projects or protrudes downward, to some extent, with respect to the lower surface of the heater cover 27, from a non-illustrated slit formed in the lower surface of the heater cover 27.

<Discharging Rollers 28A, 28B>

The discharging roller 28A is positioned in front of the heater 26. The discharging roller 28B is apart frontward from the discharging roller 28A, and is positioned behind the discharge port 121. Each of the discharging rollers 28A and 28B is supported by the frames and extends in the left-right direction. Each of the discharging rollers 28A and 28B is rotatable about a rotation axis which is parallel to the left-right direction, by a driving force generated in a non-illustrated motor. An upper end of each of the discharging rollers 28A, 28B is located at a position in the up-down direction which is substantially same as that of the conveying surface of the conveying belt 251.

<Reference Plate 29>

The reference plate 29 is supported by the frames at a position between the discharging rollers 28A and 28B in the front-rear direction. The reference plate 29 has a supporting surface which spreads in the front-rear direction and the left-right direction at a position in the up-down direction which is substantially same as that of the conveying surface of the conveying belt 251. The supporting surface is oriented upward, and is colored white.

<CIS Unit 30>

The CIS unit 30 is positioned, in the front-rear direction, between the discharging rollers 28A and 28B, and is positioned, in the up-down direction, immediately above the reference plate 29. As depicted in FIG. 3, the CIS unit 30 has a casing 301 (an example of a “reading part-holder”) which is substantially a rectangular parallelepiped and which extends in the left-right direction (an example of a “width direction”) between the left wall 132 and the right wall 133 (see FIG. 1B); the CIS unit 30 has, inside the casing 301, an LED array 302, a rod lens array 303 and a line sensor 304 (an example of a “reading part”). The LED array 302 is a plurality of LEDs which is aligned in the left-right direction, and emits a linear light toward the reference plate 29. The rod lens arrays 303 is a plurality of rod lenses aligned in the left-right direction, and forms, on the line sensor 304, an image of a reflected right of the light reflected off the reference plate 29. The line sensor 304 has a plurality of PDs aligned in the left-right direction, and outputs data having a level corresponding to an incident light amount of an incident light to each of the plurality of PDs.

As depicted in FIG. 4, the CIS unit 30 has, in the casing 301, spur rollers 305A and 305B (each of which is an example of a “rotating body”). The spur rollers 305A, 305B are provided on positions, respectively, which are on a rear lower corner and a front lower corner inside the casing 301 and which are apart (outside) of an optical path, in the casing 301. In FIG. 4, only the spur roller 305B is depicted in an enlarged manner. Each of the spur rollers 305A, 305B is positioned at the center in the left-right direction of the casing 301, and is supported by the casing 301 to be rotatable about a rotation axis which is parallel to the left-right direction. Each of the spur rollers 305A, 305B protrudes downward, to some extent, with respect to the lower surface of the casing 301, from a slit formed in the lower surface of the casing 301. A lower end of each of the spur roller 305A, 305B is located at a position in the up-down direction which is substantially same as that of the conveying surface of the reference plate 29.

<Spur Holder Unit 31>

As depicted in FIGS. 3 and 4, in the internal space 11 of the casing cover 13, an accommodating space 134A and an accommodating space 134B are defined, respectively, at a location immediately behind and a location immediately in front of the casing 301. The accommodating space 134A is defined in front of the heater cover 27 (see FIG. 3). Each of the accommodating spaces 134A, 134B is opened downward. A pair formed of two supporting members 311A and a pair formed of two supporting members 311B are attached to the casing cover 13, respectively, in the accommodating space 134A and the accommodating space 134B (see FIG. 4). One and the other of the two supporting members 311A are positioned on the rear side with respect to the casing 301 in the front-rear direction, and the two supporting members 311A are positioned, respectively, on the left side and the right side with respect to the casing 301 in the left-right direction. One and the other of the two supporting members 311B are positioned on the front side with respect to the casing 301 in the front-rear direction, and the two supporting members 311B are positioned, respectively, at substantially same positions as those of the two supporting members 311A. A columnar-shaped shaft 312A and a columnar-shaped shaft 312B are stretched, respectively, between the two supporting members 311A and between the two supporting member 311B to be parallel to the left-right direction.

As depicted in FIGS. 3 to 5, a spur holder unit 31 is detachably attached with respect to the shafts 312A and 312B. In a case that the spur holder unit 31 is installed in the shafts 312A and 312B, the spur holder unit 31 is accommodated in the accommodating spaces 134A and 134B (see FIG. 5), and is positioned above the discharging rollers 28A and 28B (see FIG. 3). In the following description, unless particularly noted, the term “spur holder unit 31” means the “spur holder unit 31 installed in the shafts 312A, 312B and accommodated in the accommodating spaces 134A, 134B”.

As depicted in FIGS. 5 and 6, the spur holder unit 31 has spur holders 313A, 313B, connecting members 314A, 314B and fitting parts 315A, 315B.

<Spur Holders 313A, 313B>

Each of the spur holders 313A, 313B has a substantially rectangular parallelepiped shape which is long in the left-right direction; in a case that the spur holder unit 31 is installed in the shafts 312A, 312B, the spur holder unit 31 is accommodated and positioned in the accommodating spaces 134A, 134B. In this situation, the spur holder 313A (an example of an “upstream-side holder”) is positioned on the upstream side in the conveying direction with respect to the rear wall of the casing 301, via a gap 316A (an example of a “first gap”, see FIG. 3). The spur holder 313B (an example of a “downstream-side holder”) is positioned on the downstream side in the conveying direction with respect to the front wall of the casing 301, via a gap 316B (an example of a “second gap”, see FIG. 3). Note that in a case that the spur holder unit 31 is being installed in the shafts 312A, 312B, gaps are also defined, respectively, at locations immediately above, both on the left and right sides of, and immediately behind of each of the spur holders 313A, 313B. A plurality of spur rollers 317A and a plurality of spur rollers 317B are arranged side by side in the left-right direction, respectively, in the spur holder 313A and the spur holder 313B (see FIG. 6). Each of the plurality of spur rollers 317A is supported by the spur holder 313A to be rotatable about a rotation axis parallel to the left-right direction; and each of the plurality of spur rollers 317B is supported by the spur holder 313B to be rotatable about a rotation axis parallel to the left-right direction. A lower end of each of the plurality of spur rollers 317A projects or protrudes, to some extent, from a slit 318A formed in the spur holder 313A and makes contact with an upper end of the discharging roller 28A (see FIG. 3); and a lower end of each of the plurality of spur rollers 317B projects or protrudes, to some extent, from a slit 318B formed in the spur holder 313B and makes contact with an upper end of the discharging roller 28B (see FIG. 3). The plurality of spur rollers 317A, 317B each has a diameter greater than those of the spur rollers 305A, 305B. The plurality of spur rollers 317A (each of which is an example of an “upstream-side rotating body”) is arranged on the upstream side in the conveying direction with respect to the spur roller 305A, and the plurality of spur rollers 317B (each of which is an example of a “downstream-side rotating body”) is arranged on the downstream side in the conveying direction with respect to the spur roller 305B.

The connecting member 314A is a flat plate extending in the front-rear direction at a position on the left side with respect to the casing 301, and connects left ends, respectively, of the spur holders 313A, 313B to each other. The connecting member 314B is a flat plate extending in the front-rear direction at a position on the right side with respect to the casing 301, and connects right ends, respectively, of the spur holders 313A, 313B to each other.

As depicted in FIG. 6, the fitting part 315A has projecting parts 3151A to 3153A, fitting pieces 3154A, 3155A and fitting pieces 3156A, 3157A, as main members thereof. These main members extend rearward from a rear wall 3131A of the spur holders 313A.

The projecting part 3151A is located at a position which is the center in the left-right direction and which is in the vicinity of an upper end of the rear wall 3131A. The projecting part 3151A has a shape which is substantially of a letter “U” which is vertically inverted as seen from the rear side, and has a lower end which extends parallel to the front-rear direction. The projecting part 3152A is located at a position which is obliquely left and lower side of the projecting part 3151A; the projecting part 3153A is located at a position which is obliquely right and lower side of the projecting part 3151A. The projecting parts 3152A and 3153A are apart downward from the lower end of the projecting part 3151A. Each of the projecting parts 3152A, 3153A has an upper surface spreading in the front-rear direction and the left-right direction at a location close to a forward end thereof. A distance L1 in the up-down direction between the lower end of the projecting part 3151A and upper surface of each of the projecting parts 3152A, 3153A is slightly shorter than the diameter of the shaft 312A.

The fitting piece 3154A is located at a position which is along a left end and is close to a lower part of the rear wall 3131A, and spreads in the up-down direction and the front-rear direction. The fitting piece 3155A is located at a position which is obliquely right and upper side with respect to the fitting piece 3154A, and spreads in the up-down direction. There is a part equal to the distance L1 between an upper edge of the fitting piece 3154A and a lower edge of the fitting piece 3155A.

As compared with the fitting pieces 3154A, 3155A, since the fitting pieces 3156A, 3157A are similar to the fitting pieces 3154A, 3155A except for a point that the fitting pieces 3156A, 3157A are positioned on the side of a right end of the rear wall 3131A, any explanation therefor will be omitted.

The fitting part 315B has eight pieces of a fitting piece 3151B, three pieces of a connecting piece 3152B and five pieces of a projecting part 3153B. Each of the eight fitting pieces 3151B and the five projecting parts 3153B projects frontward from the front wall 3131B of the spur holder 313B.

Four fitting pieces 3151B among the eight fitting pieces 3151B are arranged side by side in the left-right direction at a spacing distance therebetween, in the vicinity of the center in the left-right direction of the front wall 3131B. Other two fitting pieces 3151B are arranged side by side in the left-right direction at a spacing distance therebetween, in the vicinity of a left end of the front wall 3131B. The remaining two fitting pieces 3151B are arranged side by side in the left-right direction at a spacing distance therebetween, in the vicinity of a right end of the front wall 3131B. Each of the eight fitting pieces 3151B extends frontward from the front wall 3131B, and spreads in the up-down direction and the front-rear direction. The outer shape of each of the eight fitting pieces 3151B is substantially a shape of the letter “U” in the plane view from the left-right direction, and the eight fitting pieces 3151B overlap with one another in the plane view from the left-right direction. The three connecting pieces 3152B connect, respectively, front ends of the four fitting pieces 3151B in the vicinity of the center in the left-right direction of the front wall 3131B, front ends of the other two fitting pieces 3151B in the vicinity of the left end of the front wall 3131B, and front ends of the remaining two fitting pieces 3151B in the vicinity of the right end of the front wall 3131B.

Each of the five projecting parts 3153B projects, in the front wall 3131B, frontward to some extent from a position facing the vicinity of upper ends of the fitting pieces 3151B. Each of the five projecting parts 3151B is formed between two fitting pieces 3151B, among the eight fitting pieces 3151B, which are adjacent in the left-right direction. A distance L2 between a projecting end of each of the five projecting parts 3153B and the upper end of one of the eight fitting pieces 3151B is slightly shorter than the diameter of the shaft 312B.

<Installment of Spur Holder Unit 31>

The spur holder unit 31 having the above-described configuration is installed in the casing cover 13 via the shafts 312A, 312B in the following manner.

As depicted in FIGS. 4 to 6, the user fits the shaft 312A to the fitting part 315A. Specifically, the user fits the shaft 312A between the projecting part 3151A and the projecting parts 3152A, 3153A against an elastic force of each of the projecting parts 3151A to 3153A. Similarly, the user also fits the shaft 312A between the fitting pieces 3154A, 3135A and between the fitting pieces 3136A, 3137A.

Next, the user fits the shaft 312B to the fitting part 315B. Specifically, the user rotates the spur holder unit 31 upward up to a position at which the spur holder unit 31 approaches closely to the shaft 312B, with the shaft 312A fitted to the fitting part 315A as the center of rotation. The user fits the shaft 312B to the part having the shape of the letter “U” of each of the eight fitting pieces 3151B against the elastic force of each of the eight fitting pieces 3151B and the five projecting parts 3153B. With this, the five projecting parts 3153B make contact with the shaft 312B from thereabove, thereby preventing the occurrence of such a situation that the spur holder unit 31 falls downward from the shaft 312B. In such a manner, the spur holder unit 31 is installed in the casing cover 13 via the shafts 312A, 312B. In this situation, the spur holders 313A, 313B are positioned, respectively via the gaps 316A, 316B, with respect to the casing 301.

<Cooling Unit 32>

As depicted in FIG. 2, the cooling unit 32 is positioned, in the casing cover 13, above the heater cover 27, the CIS unit 30 and the spur holder unit 31. As depicted in FIG. 7, the cooling unit 32 has a shape of a rectangular parallelepiped which is long in the left-right direction, and has an inlet port 321, an exhaust port 322, a duct 323, two suction fans 324 (each of which is an example of a “blower”), an exhaust fan 325 (an example of “another blower”), and a filter 326.

The inlet port 321 is positioned above the heater cover 27 in the right wall 133 of the casing cover 13 (see FIG. 7B). As depicted in FIG. 7A, the exhaust port 322 is formed, in the left wall 132 of the casing cover 13, at a position on the left side with respect to the inlet port 321. Each of the inlet port 321 and the exhaust port 322 communicates the outside of the casing 1 and the internal space 11 so that the air passes therebetween.

As depicted in FIGS. 7A and 7B, the duct 323 has a rear wall 3231, a front wall 3232, an upper wall 3233, a lower wall 3234 and a partition wall 3235, at a location above the heater cover 27; the duct 323 partitions or demarcates, from the internal space 11, a gas channel 3236 of the air from the inlet port 321 to the exhaust port 322.

The rear wall 3231 spreads in the up-down direction and the left-right direction, between a front end of the recording head 24 and a rear end of the heater cover 27 in the front-rear direction. A thorough hole 3237 which is long in the left-right direction is formed in the rear wall 3231 at a part thereof near to the lower end of the rear wall 3231.

The front wall 3232 spreads in the up-down direction and the left-right direction, at a location near to a rear end of the CIS unit 30 in the front-rear direction. Two through holes 3238 are arranged side by side at a spacing distance therebetween in the left-right direction, at a position in the front wall 3232 which is closer to the upper side thereof.

The partition wall 3235 partitions or divides the gas channel 3236 into a gas supply channel 3236A and a gas exhaust channel 3236B. As depicted in FIG. 7A, the gas supply channel 3236A has a substantially shape of the letter “L” in the plan view, and starts from the inlet port 321 and reaches each of the two through holes 3238, as indicated by an arrow 91. The gas exhaust channel 3236B has a substantially rectangular shape in the plane view, and starts from the through hole 3237 and reaches the exhaust port 322, as indicated by an arrow 92.

Each of the two suction fans 324 is a centrifugal fan, a sirocco fan, etc., and is attached to a front surface of the front wall 3232. An inlet port of each of the two suction fans 324 is positioned with respect to one of the two through holes 3238. As depicted in FIG. 7B, an exhaust port of each of the two suction fans 324 is positioned above the casing 301 of the CIS unit 30.

The exhaust fan 325 is an axial fan, etc. An inlet port of the exhaust fan 325 is oriented toward the gas exhaust channel 3236B, and an exhaust port of the exhaust fan 325 is positioned with respect to the exhaust port 322.

The filter 326 is a filter for a fan, and is attached so as to cover the inlet port of the exhaust fan 325.

<Operation of Printer 100>

As depicted in FIG. 2, in a case that the printer 100 receives print data indicating an image to be recorded on the sheet S from an information processing apparatus (for example, a PC) which is capable of communicating with the printer 100, the printer 100 executes an image recording. In the image recording, the roll holder 21, the driving roller 231, the conveying belt 251 and the discharging rollers 28A, 28B rotate. With this, the sheet S is fed out from the roll holder 21 and is conveyed toward the tensioner 22. The conveyor 23 nips the sheet S from the tensioner 22, and feeds the sheet S frontward (an example of the conveying direction). The conveying belt 251 frictionally conveys, further frontward, the sheet S fed out from the conveyor 23 by the conveying surface, of the conveying belt 251, which runs frontward. The supporting part 25 supports the sheet S at the locations, respectively, on the left side and on the right side of the conveying belt 251, with the supporting surface of the supporting part 25. The recording head 24 discharges the ink from the respective nozzles 241 based on the print data and toward the sheet S supported by the supporting mechanism 25. With this, the image is recorded on the sheet S. The sheet S on which the image recording has been performed is fed to the location between the heater 26 and the heater cover 27, and is conveyed further frontward on the supporting surface of the heater 26. The heat is applied to the sheet S by the heater 26. By the heating, the thermoplastic resin fine particles on the sheet S or in the inside of the sheet S are melt and the water content is evaporated. Then, in a case that the ink is dried, the image is fixed to the sheet S.

The sheet S is conveyed further frontward by the discharging rollers 28A and the spur rollers 317A, and by the discharging roller 28B and the spur rollers 317B, and is discharged from the discharge port 121. Between the discharging rollers 28A, 28B, the sheet S is conveyed on the reference plate 29. The spur rollers 305A, 305B have the diameters which are smaller than those of the spur rollers 317A, 317B, and the spur rollers 305A, 305B press the sheet S from thereabove at a position closer to the reference plate 29 than the spur rollers 317A, 317B. The CIS unit 30 optically reads the image recorded on the sheet S, and outputs read data indicating the result of reading to the controller. The controller determines or judges the quality of the image recorded on the sheet S, based on the read data.

<Channel of Air Flow (An Example of Channel) in Cooling Unit 32>

The two suction fans 324 and the exhaust fan 325 rotate to thereby cause the air to flow from the suction port 321 along the gas channel 3236A, passes through the two through holes 3228 and flows into the respective two suction fans 324, as indicated by the arrow 91 in FIGS. 7A and 7B. Each of the two suction fans 324 discharges the air from the exhaust port thereof, as indicated by an arrow 93. This air blows against the CIS unit 30 from thereabove, then passes mainly through the gaps 316A, 316B each between the CIS unit 30 and the spur holder unit 31. Afterwards, the air blows against the sheet S, from thereabove, the sheet S being conveyed between the discharging rollers 28A, 28B in the conveying path 33. A part of the air blown against the sheet S flows to the downstream side in the conveying path along the sheet S, and is discharged (exhausted) to the outside of the casing 1 from the discharge port 121. Further, since the exhaust fan 325 is rotating, another part of the air blown against the sheet S flows along the sheet S toward the upstream side in the conveying direction, between the plurality of spur rollers 317A and the discharging roller 28 and between the heater 26 and the heater cover 27, as indicated by an arrow 94 in FIG. 7B. Afterwards, this air flows into the exhaust channel 3226B from the through hole 3237 formed in the duct 323, flows in the inside of the exhaust channel 3236B, and is exhausted to the outside of the casing 1 from the exhaust port 322 via the filter 326 and the exhaust fan 325.

<Operation of Effect of Printer 100>

In the present embodiment, since the heat is applied to the sheet S and/or the ink image (image formed by the ink), the water content contained in the ink is evaporated. Depending on the positional relationship in the front-rear direction between the heater 26 and the CIS unit 30, the evaporation of the water content continues also between the discharging rollers 28A, 28B in the conveying path 33. In a case that the water content is evaporated at this position, the CIS unit 30 is cooled by the colling unit 32, thereby making the dew condensation to be easily occur between the sheet S and the CIS unit 30. In a case that a water droplet due to the dew condensation falls on the sheet S, there is such a fear that the image on the sheet S might be blurred. In the present embodiment, however, as indicated by the arrow 94 in FIG. 7B, the air flow toward the upstream side in the conveying direction along the sheet S is formed between the plurality of spur rollers 317A and the discharging roller 28A and between the heater 26 and the heater cover 27. By this air flow, it is possible to blow (scatter) the water vapor generated from the sheet S, and to prevent the water vapor from entering into the location in the vicinity of the casing 301 of the CIS unit 30. With this, the water droplet due to the dew condensation is less likely to adhere to the CIS unit 30, thereby making it possible to prevent the water droplet due to the dew condensation from falling on the sheet S. Further, by allowing the air flow to be blown against the sheet S which is (being) conveyed in the conveying path 33, the ink on the sheet S is dried quickly.

In the present embodiment, as depicted in FIG. 2, the recording head 24 and the CIS unit 30 are located above the conveying path 33, namely, located at the positions, respectively, facing the recording surface, in the sheet S, in which the image is (to be) recorded. On the other hand, the heater 26 is located at the position facing the surface (an example of a “second surface”), in the sheet S, which is on the opposite side to the recording surface in the sheet S. With this, since the heater 26 does not make contact with the image recorded on the sheet S, any lowering in the image quality which would be otherwise caused by the contact between the sheet S and the heater 26 does not occur.

In the present embodiment, the suction fans 324, the casing 301 and the spur holder unit 31 generate the air flow which passes through the gaps 316A, 316B and blows against the recording surface of the sheet S. With this, the water vapor on the recording surface is blown or scattered. With this, the water droplet due to the dew condensation is prevented from falling onto the sheet S, and the ink on the sheet S is dried quickly.

In the present embodiment, the casing 301 and the spur holder unit 31 define the gap 316A, 316B via which the air flow from the suction fans 324 passes. Accordingly, there is no need to provide any dedicated duct for allowing the air flow from the suction fans 324 to pass therethrough.

In the present embodiment, each of the spur rollers 305A, 305B having the small diameters presses the sheet S from thereabove at the position closer to the reference plate 29 than the plurality of spur rollers 317A and the plurality of spur rollers 317B having the large diameters. With this, since the sheet S is along the supporting surface of the reference plate 29 satisfactorily, the positioning of the sheet S with respect to the CIS unit 30 can be performed more precisely.

In the present embodiment, the heater cover 27, the CIS unit 30 and the spur holder unit 31 have the spur rollers. By providing the spur rollers, a contact surface with respect to the recording surface of the sheet S is reduced, as compared with a case provided with columnar-shaped rollers.

In the present embodiment, the plurality of spur rollers 317A is arranged side by side in the left-right direction at the spacing distance therebetween, in the spur holder 313A. This is similar to the plurality of spur rollers 317B. With this, it is possible to suppress any variation (fluctuation) in the left-right direction with respect to the distance in the up-down direction between the CIS unit 30 and the sheet S.

In the present embodiment, since the air between the plurality of spur rollers 317A and the discharging roller 28A and the air between the heater 26 and the heater cover 27 are sucked to the exhaust channel 3226B by the exhaust fan 325 and the duct 323, as indicated by the arrow 94 in FIG. 7B, the water droplet due to the dew condensation is prevented from falling onto the sheet S, and the ink on the sheet S is dried quickly.

In the present embodiment, since the filter 326 is attached to the suction port of the exhaust fan 325, any foreign matter included in the air flow is not discharged (exhausted) to the outside of the casing 1.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

<Modifications>

In the above-described embodiment, the printer 100 discharges the ink from the recording head 24 to thereby record an ink image on the sheet S. It is allowable, however, that the printer 100 records an ink image on the sheet S by a rotary press (another example of the “recording part”), rather by the recording head 24.

In the above-described embodiment, the printer 100 is provided with the film heater 262. It is allowable, however, that the printer 100 may be provided with a halogen heater, rather than the film heater 262.

In the above-described embodiment, the printer 100 discharges the sheet S from the discharge port 121. The present disclosure, however, is not limited to this. The printer 100 may take up the sheet S, for which the image recording has been performed, with a winding device provided on the inside of the casing 1.

In the above-described embodiment, the printer 100 optically reads the image recorded on the sheet S, by an active sensor such as a so-called CIS. However, the printer 100 may optically read the image recorded on the sheet S by a passive sensor such as a camera, instead of using the CIS.

The present disclosure may be applied in the following aspect.

Each of the recording part and the reading part may be located at a position facing a first surface of the sheet conveyed by the conveyor. The heater may be located at a position facing a second surface, on an opposite side to the first surface, of the sheet conveyed by the conveyor.

Since the heater does not make contact with the first surface on which the image is recorded, the image quality is not lowered.

The blower may be configured to generate the air current toward the first surface of the sheet which has reached the position at which the reading part faces the first surface.

Water vapor on the side of the first surface of the sheet which has reached the position at which the reading part faces the sheet is blown by the air current of the blower. Accordingly, any adhesion of the water droplet to the first surface of the sheet is suppressed, and the ink is dried quickly.

The casing may have a conveying path via which the sheet is conveyed by the conveyor. The image recording apparatus may further include: a reading part-holder configured to support the reading part; an upstream-side holder positioned on an upstream of the reading part-holder with a first gap in the conveying direction, and configured to support an upstream-side rotating body configured to make contact with the sheet; and a downstream-side holder positioned on the downstream of the reading part with a second gap in the conveying direction, and configured to support a downstream-side rotating body configured to make contact with the sheet. A distance from the blower to the conveying path may be longer than a distance from the reading-part holder to the conveying path. The air current generated by the blower may pass the first gap and the second gap, and may blow against the sheet at the position which is on the downstream of the heater in the conveying direction.

Since the air current passes through the first gap and the second gap, there is no need to provide a duct, for the air current, starting from the blower and reaching up to the sheet which has arrived at the position at which the reading part faces the sheet.

The reading part-holder may have rotating bodies which are located, respectively, on the upstream and the downstream of the reading part in the conveying direction.

It is possible to position the sheet with respect to the reading part, with a high precision, by the rotating bodies.

The reading part-holder may extend in a width direction which crosses the conveying direction and which is along a plane of the sheet. Each of the rotating bodies may be located at a center in the width direction in the conveying path.

Each of the rotating bodies may be a spur roller.

By making each of the rotating bodies to be the spur roller, the contact with respect to the first surface is suppressed.

The upstream-side holder and the downstream-side holder may extend in the conveying path along a width direction which crosses the conveying direction and which is along a plane of the sheet. The image recording apparatus may further include a connecting member which is configured to connect the upstream-side holder and the downstream-side holder at a location which is outside in the width direction of the reading part-holder.

The upstream-side holder and the downstream-side holder may extend along a width direction which crosses the conveying direction and which is along a plane of the sheet. The upstream-side rotating body may be provided as a plurality of upstream-side rotating bodies arranged in the width direction in the upstream-side holder. The downstream-side rotating body may be provided as a plurality of downstream-side rotating bodies arranged in the width direction in the downstream-side holder.

By providing the upstream-side rotating body and the downstream-side rotating body as, respectively, the plurality of upstream-side rotating bodies and the plurality of downstream-side rotating bodies, any variation or fluctuation in the width direction of the distance between the reading part and the sheet is suppressed.

Each of the upstream-side rotating body and the downstream-side rotating body may be a spur roller.

By making each of the upstream-side rotating body and the downstream-side rotating body to be the spur roller, the contact with respect to the first surface is suppressed.

The casing further may have an exhaust port. The image recording apparatus may further include: a duct having a through hole which is positioned between the recording part and the heater in the conveying direction, the duct being configured to define a gas channel connecting the through hole and the exhaust port; and another blower configured to generate an air current from the through hole toward the exhaust port.

It is possible to guide the air current toward the exhaust port via the duct.

The image recording apparatus may further include a filter located in the gas channel.

It is possible to prevent any foreign matter from being exhausted to the outside of the casing.

What is claimed is:

1. An image recording apparatus comprising:
a casing;
a conveyor positioned inside the casing and configured to convey a sheet in a conveying direction;
a recording part positioned inside the casing and configured to record an image, with an ink, on the sheet conveyed by the conveyor;
a heater positioned inside the casing, on a downstream of the recording part in the conveying direction, and configured to heat the sheet and/or the ink;
a reading part positioned inside the casing, on a downstream of the heater in the conveying direction, and configured to optically read the image recorded on the sheet; and
a blower positioned inside the casing and configured to generate an air current toward the reading part and toward the sheet located at a position on the downstream of the heater in the conveying direction.

2. The image recording apparatus according to claim 1, wherein
each of the recording part and the reading part is located at a position facing a first surface of the sheet conveyed by the conveyor, and
the heater is located at a position facing a second surface, on an opposite side to the first surface, of the sheet conveyed by the conveyor.

3. The image recording apparatus according to claim 2, wherein
the blower is configured to generate the air current toward the first surface of the sheet which has reached the position at which the reading part faces the first surface.

4. The image recording apparatus according to claim 1, wherein
the casing includes a conveying path via which the sheet is conveyed by the conveyor,
the image recording apparatus further comprising:
a reading part-holder configured to support the reading part;
an upstream-side holder positioned on an upstream of the reading part-holder with a first gap in the conveying direction, and configured to support an upstream-side rotating body configured to make contact with the sheet, and
a downstream-side holder positioned on the downstream of the reading part with a second gap in the conveying direction, and configured to support a downstream-side rotating body configured to make contact with the sheet,
a distance from the blower to the conveying path is longer than a distance from the reading-part holder to the conveying path, and
the air current generated by the blower passes the first gap and the second gap, and blows against the sheet at the position which is on the downstream of the heater in the conveying direction.

5. The image recording apparatus according to claim 4, wherein
the reading part-holder includes rotating bodies which are located, respectively, on the upstream and the downstream of the reading part in the conveying direction.

6. The image recording apparatus according to claim 5, wherein
the reading part-holder extends in a width direction which crosses the conveying direction and which is along a plane of the sheet, and
each of the rotating bodies is located at a center in the width direction in the conveying path.

7. The image recording apparatus according to claim 5, wherein
each of the rotating bodies is a spur roller.

8. The image recording apparatus according to claim 4, wherein
the upstream-side holder and the downstream-side holder extend in the conveying path along a width direction which crosses the conveying direction and which is along a plane of the sheet; and
the image recording apparatus further comprises a connecting member which is configured to connect the upstream-side holder and the downstream-side holder at a location which is outside in the width direction of the reading part-holder.

9. The image recording apparatus according to claim 4, wherein
the upstream-side holder and the downstream-side holder extend along a width direction which crosses the conveying direction and which is along a plane of the sheet,
the upstream-side rotating body is provided as a plurality of upstream-side rotating bodies arranged in the width direction in the upstream-side holder, and
the downstream-side rotating body is provided as a plurality of downstream-side rotating bodies arranged in the width direction in the downstream-side holder.

10. The image recording apparatus according to claim 8, wherein
each of the upstream-side rotating body and the downstream-side rotating body is a spur roller.

11. The image recording apparatus according to claim 1, wherein
the casing further includes an exhaust port, and
the image recording apparatus further comprises:
a duct having a through hole positioned between the recording part and the heater in the conveying direction, the duct being configured to define a gas channel connecting the through hole and the exhaust port; and
another blower configured to generate an air current from the through hole toward the exhaust port.

12. The image recording apparatus according to claim 11, further comprising a filter located in the gas channel.
